(19) United States
(12) Patent Application Publication
(10) Pub. No.: US 2025/0064107 A1
(43) Pub. Date: Feb. 27, 2025

(54) Smoking Filter

(71) Applicant: Snap Wrap, LLC, Sarasota, FL (US)

(72) Inventor: Paul Vegliante, Sarasota, FL (US)

(73) Assignee: Snap Wrap, LLC, Sarasota, FL (US)

(21) Appl. No.: 18/945,459

(22) Filed: Nov. 12, 2024

Related U.S. Application Data
(63) Continuation-in-part of application No. 17/340,437, filed on Jun. 7, 2021, now Pat. No. 12,137,729.
(60) Provisional application No. 63/035,248, filed on Jun. 5, 2020.

(51) Int. Cl. A24D 3/04; A24F 1/30; A24F 7/04; B65D 77/04; C09J 7/30

(52) U.S. Cl. CPC A24D 3/04; A24F 1/30; A24F 7/04; C09J 7/30; B65D 77/04; B65D 2221/00; C09J 2203/37

(57) ABSTRACT

The present disclosure relates to a filter for a smoking device, such as, but not limited to, a water pipe. The filter includes a body that is positionable over a mouthpiece of the smoking device, to filter impurities from smoke drawn therethrough, and a base that secures the body over the mouthpiece such that smoke is drawn therethrough, prior to inhalation by a user. The body can include one of more filtration layers, such as a first layer formed from a material selected to filter carcinogens and other impurities from the smoke prior to inhalation, and a second layer formed from a material selected to minimize or prevent the transmission of bacteria, viruses, or other contagions from a user's mouth to the smoking device. Each of the filtration layers can also be formed from one or more materials.

### CROSS-REFERENCE TO RELATED APPLICATIONS

This application is a continuation-in-part of, and claims priority to, U.S. patent application Ser. No. 17/340,437, filed on Jun. 7, 2021, now U.S. Pat. No. 12,137,729, issued on Nov. 12, 2024, which claims the benefit of U.S. Provisional Patent Application No. 63/035,248, filed on Jun. 5, 2020, the entire contents of which are expressly incorporated herein by reference.

### BACKGROUND

### Field of the Disclosure

The present disclosure relates to a filter for a smoking apparatus.

### Related Art

Water pipes, and other smoking paraphernalia, such as bongs, use water to filter and cool smoke prior to inhalation. However, not all particles are filtered by water. Other smoking paraphernalia, such as pipes and bowls, contain no filters. Further, such smoking paraphernalia is often shared among people, potentially leading to transmission of contagions from one person to another.

Furthermore, there remains a problem of unwanted contaminants in smoke. Common smoke contaminants include microbes, heavy metals, and pesticides. Smoke formulations and administration routes affect the transformation and bioavailability of contaminants. See Dryburgh et al., Brit. J. Clin. Pharmacol. 84:2468-76 (2018). Removal of such contaminants would enhance the smoke experience and reduce toxic effects.

### SUMMARY

The present disclosure relates to a smoking filter for a water pipe and other smoking devices. The smoking filter includes a body having one or more filter layers that can be positioned over an open top of the water pipe and an elastic base sized to fit about an open top of the water pipe in order to secure the body of the filter to the top of the water pipe. The filter has a first, generally flat, configuration for positioning inside a package for sale and storage, and a second, deployed, configuration for positioning the body over the open top of the water pipe and the elastic base positioned about the side wall of the open top to secure the body to the open top. The body of the smoking filter can exceed the size of the open top of the water pipe and have a plurality of filter layers comprising various materials. For example, the body can be formed from a woven and a non-woven material and can comprise one or more filter agents, such as charcoal. According to another example, the smoking filter can include a first layer formed from a material that filters carcinogens and other impurities from the smoke prior to inhalation and a second layer formed from a material that minimizes or prevents transmission of bacteria, viruses, or other contagions from a user's mouth to the water pipe. A layer can include an antimicrobial material such as a metal coating of silver and copper. One or more layers, or a portion of one or more layers can comprise an N95 filter or other filter materials such as a face mask filter.

The smoking filter can include a body having one or more filter layers, a first generally planar portion, and a central portion that extends from the planar portion into the open top of the water pipe and an elastic base sized to fit about the open top of the water pipe to secure the body of the filter on the open top. The central portion is inserted into the pipe and can be, for example, conical, frustoconical, cylindrical etc.

One aspect is for a smoking filter comprising: a first layer comprising a non-woven thermoplastic polymer fiber and a second layer comprising a non-woven thermoplastic bicomponent polymer fiber, the first layer being deposed on the second layer; a body positionable over a mouthpiece of a smoking device to filter impurities from smoke drawn therethrough; and a resiliently deformable base configured to secure the body over a mouthpiece such that smoke is drawn therethrough prior to inhalation by a user. In some embodiments, the first layer non-woven thermoplastic polymer fiber is a non-woven polypropylene fiber; and in some embodiments, the non-woven polypropylene fiber is a needlepunch non-woven polypropylene fiber. In some embodiments, the second layer non-woven thermoplastic bicomponent polymer fiber is a non-woven polypropylene/polyethylene fiber; and in some embodiments, the non-woven polypropylene/polyethylene fiber is a through-air bonded non-woven polypropylene/polyethylene fiber. In some embodiments, the first layer is detachably deposed on the second layer. In some embodiments, the base comprises an elastic ring secured about a lower edge of the body, the lower edge of the body being wrapped around the elastic ring. In some embodiments, the base comprises a cylindrical collar and a retaining ring, the cylindrical collar sized to extend about a sidewall of a mouth of the smoking device, and the retaining ring bearing against a sidewall of the mouth to retain the body over a mouth of the smoking device; in some embodiments, the retaining ring is formed from an elastic material such that the base can be stretched to accommodate smoking devices having different sizes and configurations; in some embodiments, the body comprises a central portion that that extends from the collar into a mouthpiece of a smoking device; and in some embodiments, the central portion is formed from a rigid or semi-rigid material and is integrally formed with the collar. In some embodiments, the first layer and the second second layer have a combined fabric weight in a range of about90 to about 130 grams per square meter (GSM); in some embodiments, the first layer has a fabric weight of about 70 to about 110 GSM; and in some embodiments, the second layer has a fabric weight of about 10 to about 28 GSM.

Another aspect is for a method of reducing contaminants from smoke comprising: (a) removably attaching the aforementioned smoking filter to a smoking device; and (b) drawing smoke through the smoking filter removably attached to the smoking device thereby reducing contaminants from the smoke. In some embodiments, the smoke filter has an airflow resistance of at least about 1.10 mm H2O. In some embodiments, the smoke filter has a submicron filtration efficiency of at least about 50%. In some embodiments, the particulates are tar particulates. In some embodiments, the microorganisms are bacteria, viruses, or a combinations thereof.

An additional aspect is for a smoking filter comprising: a first layer comprising a non-woven thermoplastic polymer fiber and a second layer comprising a non-woven thermoplastic bicomponent polymer fiber, the second layer being deposed on the first layer; a body positionable over a mouthpiece of a smoking device to filter impurities from smoke drawn therethrough; and a resiliently deformable base configured to secure the body over a mouthpiece such that smoke is drawn therethrough prior to inhalation by a user.

### BRIEF DESCRIPTION OF THE DRAWINGS

The foregoing features of the disclosure will be apparent from the following Detailed Description, taken in connection with the accompanying drawings, in which:

FIG. 1 is a perspective view of a water pipe;

FIG. 2 is a perspective view of a filter for the water pipe;

FIG. 3 is a cross-sectional view of the filter shown in FIG. 2 taken along lines 3-3;

FIG. 4 is a perspective view of the filter on a water pipe;

FIG. 5 is a cross-sectional view of another filter according to the present disclosure positioned on a water pipe;

FIG. 6 is a cross-sectional view of another filter according to the present disclosure positioned on a water pipe; and

FIG. 7 is a cross-sectional view of another filter according to the present disclosure formed from first and second materials.

FIG. 8 shows a filter having a rigid portion and a filter portion.

FIG. 9 shows a filter clip and filter material.

FIG. 10A shows a filter clip and a roll of filter material.

FIG. 10B shows a filter clip with arms for holding a roll of filter material.

FIG. 11 shows a filter clip with a slot for filter material.

### DETAILED DESCRIPTION

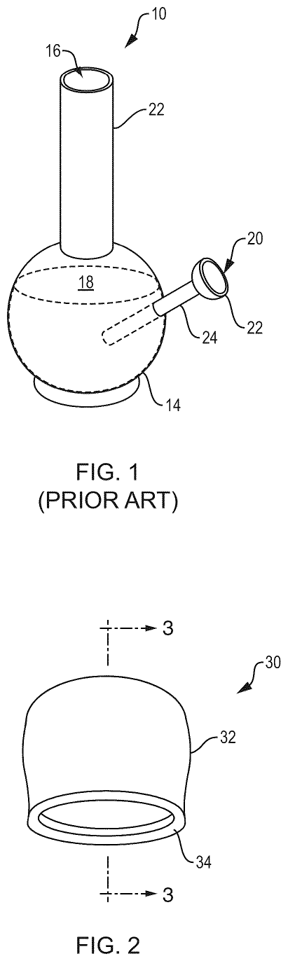

The present disclosure relates to smoking filters for water pipes and other smoking devices, as discussed in detail below in connection with FIGS. 1-11.

FIG. 1 is a perspective view of a water pipe 10 as known in the prior art. The water pipe 10 includes a cylindrical body 12 having a bottom 14 holding an amount of water 18 and an open top 16, which can serve as a mouthpiece. A bowl portion 20 includes a receptacle 22 for receiving tobacco or marijuana or other combustible substance to be smoked. A hollow tube 24 extends from the receptacle 22 to the interior of the body 12 at the bottom 14 where the water 18 is held. In operation, the combustible substance is exposed to a heat source (e.g., a flame), a smoker's mouth is placed over the open top 16, and the smoker inhales to draw smoke from the receptacle 22, through the stem 24, percolating up through the water 18, up the cylindrical body 12 and into the mouth of the smoker.

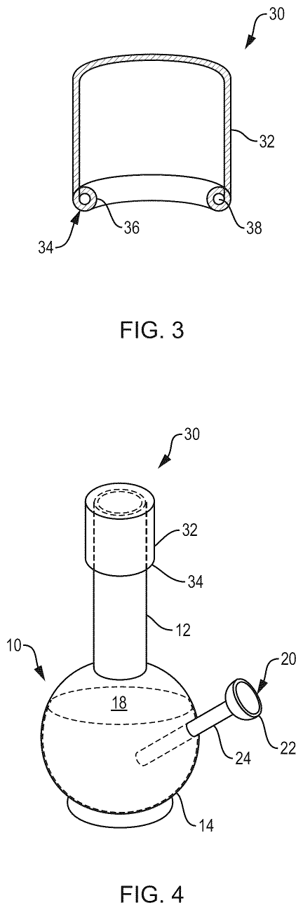

FIG. 2 shows a perspective view of an exemplary filter 30 of the present disclosure in the form of a cover for the open top 16 of the water pipe 10. FIG. 3 is a cross-sectional view of the filter shown in FIG. 2, taken along the lines 3-3. The filter 30 includes a body 32 and a base 34. As shown in FIG. 4, the filter 30 fits over the water pipe 10, or other pipe such that the body 32 covers the open top 16 and the base 34 secures the filter 30 to the cylindrical body 12 of the water pipe 10. The filter can be sized to fit the water pipe, or it can be loose to fit many sizes.

The body 32 of the filter 30 can be made of any material that permits air to pass through but helps to remove tar and other materials in smoke to help minimize the amount of tar and other materials inhaled by a person. The filter material can also minimize the transmission of pathogens by preventing the passing of such pathogens from one person's mouth to the smoking implement and to a next person's mouth. The filter material could be made of any suitable, protective material or a combination of materials. The filter could be formed from a woven or non-woven material. It could be made of nylon, for example, a nylon stocking material. The filter could also be made of cotton or any suitable synthetic material, such as a plastic material having a sufficiently fine air throughput to filter tar and other impurities from smoke, and to prevent the transmission of pathogens, but to allow smoke to be inhaled therethrough. A charcoal or charcoal impregnated filter can be included to increase filtering. There is a limit on the level of filtration in that if the level of filtration is too high, it will be difficult for a user to draw smoke through the filter. The filter 30 can have sufficient play such that it can be moved about the open end of a pipe so a user can position an unused portion at the end of the pipe for use.

The filter 30 could be formed from one layer. Such a single layer could filter and decrease or remove tar and protect against pathogens. Alternatively, the filter 30 could be formed of a plurality of layers, with one or more materials for each layer being selected to perform a specific function. For example, a first layer could be formed from a material selected to perform the function of filtering carcinogens and other impurities from the smoke prior to inhalation. A second layer could be formed from a material selected to perform the function of minimizing or preventing transmission of bacteria, viruses, or other contagions from a user's mouth to the smoking paraphernalia, or conversely, from the smoking paraphernalia to the user's mouth. Suitable materials for the second layer can include, but are not limited to, antimicrobial/antibacterial materials and coatings, such as silver and copper.

The filter 30 could have a number of different components. For example, the side walls of the filter could be made of a soft rubber or plastic material, such as a pvc material, pvc film, or other material, to engage or stick to the side wall of the water pipe. The filter media could be a different material, such as paper, a non-woven material, or other filter materials, joined to the side walls of the filter. The filter could be hard or soft. A hard cap made of glass or plastic or other rigid material can be placed on the water pipe and the hard cap can have a filter media. The filter media could be removable and replaceable on a hard cap, or the hard cap and filter media together could be removed from the pipe and replaced after use. Any suitable material can be used to retain the filter or cap on the water pipe. For example, a material that can cling to the outer surface of the pipe can be used to retain the filter or cap on the pipe. A non-permanent adhesive can be used, as can rubber bands, or any material that functions like a rubber band and can exert pressure on the exterior of the pipe and/or can cling to, or adhere to, the exterior of the pipe. Tape can be used to attach the filter or cap to a water pipe, as can any material that can function like a rubber band, for example, a nylon material. As such, the filter can be comprised entirely of the filter media, or the filter can include filter media and other components.

The base 34 of the filter 30 can be made of any suitable material for retaining the filter on a water pipe or other smoking device. The base 34 can be made of an elastic material 38 that can be stretched over the body of the pipe to retain the filter 30 on the pipe. For example, an elastic material 38, such as a rubber band, can be attached about an edge of the filter 30. The edge of the body 32 of the filter 30 can be wrapped around the elastic material 38 or rubber band and sewn or otherwise attached to itself to form a pocket 36 enclosing the elastic material 38 about the edge of the filter 30. The base could additionally or alternatively include an adhesive to adhere the filter to adhere the filter to a pipe. The adhesive could be a light adhesive or releasable adhesive or a tacky material or a tack agent to hold the filter in place on a pipe.

In use, one can place the filter 30 on a water pipe 10 as shown in FIG. 4. One can then use the water pipe. When a person is finished using the pipe, the filter can be removed. Another person can then place another filter on the water pipe and use the water pipe. The filter 30 helps to minimize the likelihood of one person passing pathogens to another person because people are contacting their mouths with a filter and not directly with pipe. The filter 30 can also filter tar and other materials in the smoke to help minimize the amount of tar and other materials inhaled by a person.

The filter 30 can be sized for its intended use. For example, the filter 30 could be produced in a number of sizes such as a small size for a pipe and a larger size for a bong. The filter 30 could be packaged such that one filter is individually packaged in a single, conveniently-sized package. For example, the filter 30 could be transported or sold in individual prophylactic type packages where they are easy to carry in a wallet or purse. A box could contain multiple filters packaged in this manner.

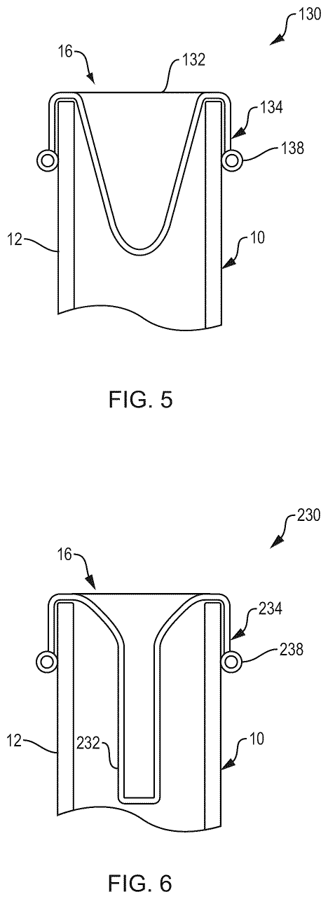

FIG. 5 is a partial cross-sectional view of another filter 130 of the present disclosure, positioned on the pipe of FIG. 1. The filter 130 includes a generally conical or frustoconical body 132 formed from a filtration media attached to a cylindrical collar 134. The filter 130 fits over the water pipe 10 such that the body 132 covers the open top 16 and at least partially extends into the cylindrical body 12 of the pipe 10 and the cylindrical collar 134 secures the filter 130 to the cylindrical body 12 of the water pipe 10. As shown, the generally conical or frustoconical body 132 of the filter 130 provides for a filtration media surface area that is greater than the area of the open top 16 of the pipe 10. Accordingly, tar and other materials in smoke drawn through the open top 16 of the pipe 10 are filtered through the larger filtration media surface area of the body 132, thereby providing for improved filtration and an enhanced user experience.

The body 132 of the filter 130 can be made of any filtration media that permits air to pass through but helps to remove tar and other materials in smoke, to help minimize the amount of tar and other materials inhaled by a person. The cylindrical collar 134 of the filter 130 can be made of any suitable material for retaining the filter 130 on the water pipe 10 or other smoking device. For example, as shown in FIG. 5, the cylindrical collar 134 can be made from the same filtration media as the body 132 and can be integrally formed therewith. The cylindrical collar 134 can also include a retaining ring 138 attached about an edge of the filter 130 that can be stretched over the body 12 of the pipe 10 to retain the filter 130 on the pipe 10. The retaining ring 138 can be formed from a resiliently deformable or elastic material, such as elastic or a rubber band, so that the collar 134 of the filter 130 can stretched to accommodate a variety of smoking devices having different sizes and configurations.

FIG. 6 is a partial cross-sectional view of another filter 230 of the present disclosure, positioned on a pipe. The filter 230 includes a generally cylindrical, or tubular, body 232 formed from a filtration media and a cylindrical collar 234 extending therefrom. The filter 230 fits over the water pipe 10 such that the body 232 covers the open top 16 and at least partially extends into the cylindrical body 12 of the pipe 10 and the cylindrical collar 234 secures the filter 230 to the cylindrical body 12 of the water pipe 10. As shown, the generally cylindrical body 232 of the filter 230 provides for a filtration media surface area that is greater than the area of the open top 16 of the pipe 10. Accordingly, tar and other materials in smoke drawn through the open top 16 of the pipe 10 are filtered through the larger filtration media surface area of the body 232, thereby providing for improved filtration and an enhanced user experience.

The body 232 of the filter 230 can be made of any filtration media that permits air to pass through but helps to remove tar and other materials in smoke, to help minimize the amount of tar and other materials inhaled by a person. The cylindrical collar 234 of the filter 230 can be made of any suitable material for retaining the filter 230 on the water pipe 10 or other smoking device. For example, as shown in FIG. 6, the cylindrical collar 234 can be made from the same filtration media as the body 232 and can be integrally formed therewith. The cylindrical collar 234 can also include a retaining ring 238 attached about an edge of the filter 230 that can be stretched over the body 12 of the pipe 10 to retain the filter 230 on the pipe 10. The retaining ring 238 can be formed from a resiliently deformable or elastic material, such as a rubber band, so that the collar 234 of the filter 230 can stretched to accommodate a variety of smoking devices having different sizes and configurations.

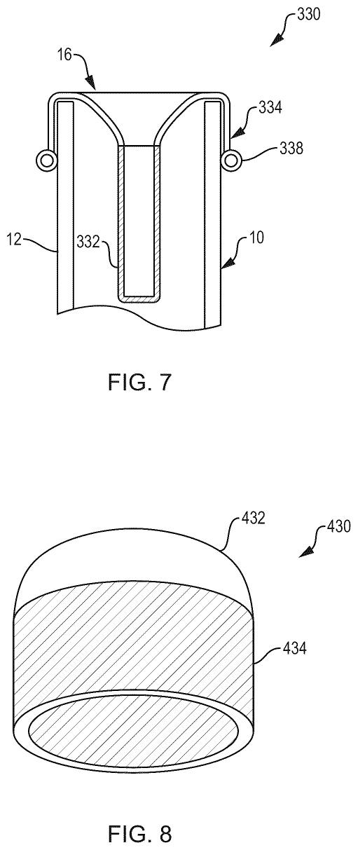

FIG. 7 is a partial cross-sectional view of another filter 330 of the present disclosure, positioned on the pipe of FIG. 1. The filter 330 includes a generally cylindrical, or tubular, body 332 formed from a filtration media and a cylindrical collar 334 extending about the filtration media. The filter 330 fits over the water pipe 10 such that the body 332 covers the open top 16 and at least partially extends into the cylindrical body 12 of the pipe 10 and the cylindrical collar 334 secures the filter 330 to the cylindrical body 12 of the water pipe 10. As shown, the generally cylindrical body 332 of the filter 330 provides for a filtration media surface area that is greater than the area of the open top 16 of the pipe 10. Accordingly, tar and other materials in smoke drawn through the open top 16 of the pipe 10 are filtered through the larger filtration media surface area of the body 332, thereby providing for improved filtration and an enhanced user experience. This larger filtration surface reduces any clogging.

The components of the filter 330, as well as the various filtration media described herein, can be formed from one or more materials. For example, as shown in FIG. 7, the body 332 of the filter 330 can be formed from a first material and the cylindrical collar 334 can be formed from a second material. Specifically, the body 332 can be formed from a rigid or semi-rigid material, N95 filtration media, other medical-grade filtration media, or another filtration media that permits air to pass through but helps to remove tar and other materials in smoke, in order to help minimize the amount of tar and other materials inhaled by a person. The cylindrical collar 334 of the filter 330 can be made of filter media such as N95 filtration media, or other media, or it could be made of an impermeable elastic membrane, or web material, or other suitable material for retaining the filter 330 on the water pipe 10 or other smoking device. The cylindrical collar 334 can also include a retaining ring 338 attached about an edge of the filter 330 that can be stretched over the body 12 of the pipe 10 to retain the filter 230 on the pipe 10. The retaining ring 338 can be formed from a resiliently deformable or elastic material, such as a rubber band, so that the collar 334 of the filter 330 can stretched to accommodate a variety of smoking devices having different sizes and configurations. It should also be understood that the body 332, the cylindrical collar 334, and/or the retaining ring 338 can be made from the same material (e.g., filtration media) as the body 332 and can be formed as an integral component.

FIG. 8 shows a filter 430 having a filter body 432 comprised of a filter material and a rigid or semi-rigid base 434. The hard cap and filter can be placed on a pipe.

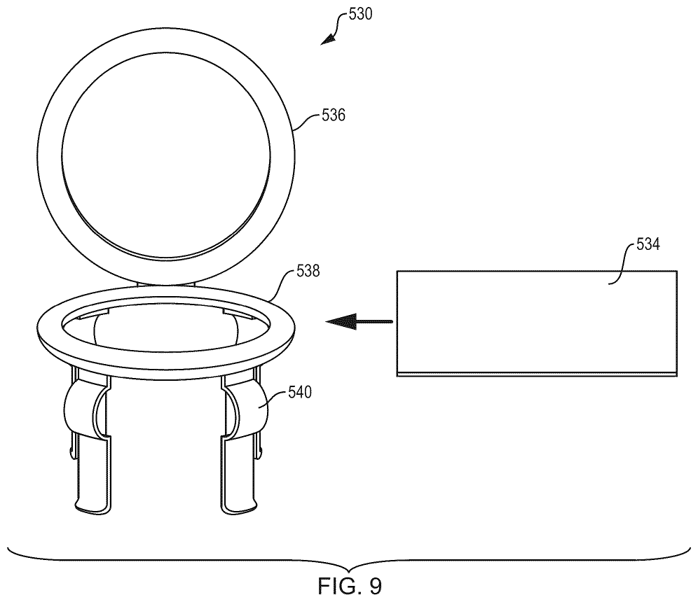

FIG. 9 shows a filter cap 530 with rings 536 and 538 for holding a filter material 534 in place for filtering smoke. The rings are moveable with respect to each other and upper ring 536 and move against the lower ring 538 to retain a filter in position on a pipe. The rings 536 and 538 can strap together. Legs 540 can engage the mouthpiece of the pipe.

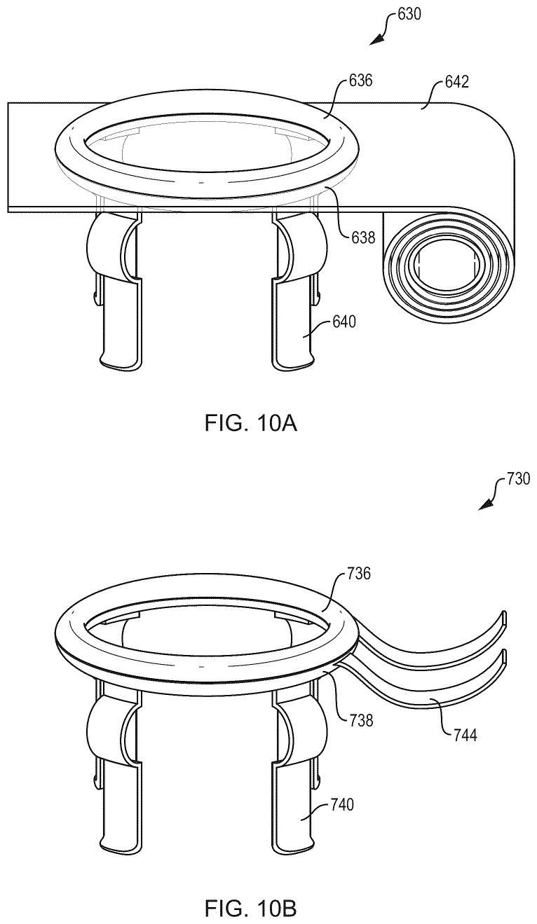

FIG. 10A shows the filter cap of FIG. 9, identified as cap 630 with a roll of filter material 642 which fed through the cap rings 636 and 638, for filtering. Legs 640 can engage the mouthpiece of the pipe.

FIG. 10B shows a filter cap 730 with rings 736 and 738 and legs 740. The cap includes arms, 744 extending from the cap 730, such as from lower ring 738, for holding a role of filter material.

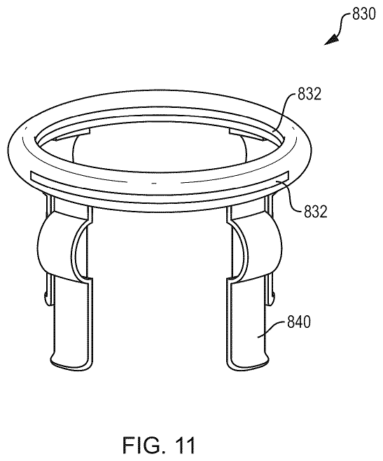

FIG. 11 shows a filter cap 830 with a slot 832 for receiving a filter media. The cap 830 can be attached to a pipe via legs 840. The filter can be adhered to the pipe, clipped to pipe, attached with a drawstring or by tying a material about the pipe and filter, or in any other way.

Also disclosed herein are smoking filters that, in some embodiments, remove smoke contaminants from smoke. A smoking filter of the present disclosure comprises, in some embodiments, a first layer comprising a non-woven thermoplastic polymer fiber and a second layer comprising a non-woven thermoplastic bicomponent polymer fiber, the first layer being deposed on the second layer; a body positionable over a mouthpiece of a smoking device to filter impurities from smoke drawn therethrough; and a resiliently deformable base configured to secure the body over a mouthpiece such that smoke is drawn therethrough prior to inhalation by a user.

As used herein, “bicomponent fibers” are fibers composed of two different polymer components. These components can have different melting points, solubilities, or other properties. In the nonwoven process, bicomponent fibers are often used to achieve specific characteristics in the final fabric. Bicomponent staple fibers are typically produced through a spinning process where polymers are extruded through a single spinneret to create a single staple fiber that is then used in many carding programs related to nonwoven media production. These bicomponent fibers can then be blended with other fibers and formed into a loose web using methods like carding or air laying, similar to single-component fibers. During bonding, the different components of the bicomponent fibers can behave differently. For example, if one component has a lower melting point than the other, it may melt and bond with neighboring fibers when subjected to heat, while the other component remains intact. This creates additional bonding points within the fabric, enhancing its strength and stability. Bicomponent fibers can be designed to impart specific properties to the nonwoven fabric, such as improved softness, thermal insulation, moisture management, or increased loft. By controlling the composition and structure of the bicomponent fibers, manufacturers can tailor the properties of the fabric to meet the requirements of various applications.

As used herein, the term “multicomponent” refers to fibers formed from at least two polymers (e.g., bicomponent fibers) that are extruded from separate extruders. The at least two polymers can each independently be the same or different from each other, or be a blend of polymers. The polymers are arranged in substantially constantly positioned distinct zones across the cross-section of the fibers. The components may be arranged in any desired configuration, such as sheath-core, side-by-side, pie, island-in-the-sea, and so forth. Various methods for forming multicomponent fibers are described in U.S. Pat. Nos. 4,789,592, 5,336,552, 5,108,820, 4,795,668, 5,382,400, 5,336,552, and 6,200,669, which are incorporated herein in their entirety by reference. Multicomponent fibers having various irregular shapes may also be formed, such as described in U.S. Pat. Nos. 5,277,976, 5,162,074, 5,466,410, 5,069,970, and 5,057,368, which are incorporated herein in their entirety by reference.

As used herein, the terms “nonwoven,” “nonwoven web” and “nonwoven fabric” refer to a structure or a web of material which has been formed without use of weaving or knitting processes to produce a structure of individual fibers or threads which are intermeshed, but not in an identifiable, repeating manner. Nonwoven webs can be formed by a variety of conventional processes such as, for example, meltblown processes, spunbond processes, staple fiber carding processes, needle punch processes, spunlace processes, chemical bonding processes, and thermal bonding processes.

As used herein, the term “meltblown” refers to a process in which fibers are formed by extruding a molten thermoplastic material through a plurality of fine, usually circular, die capillaries into a high velocity gas (e.g., air) stream which attenuates the molten thermoplastic material and forms fibers, which can be to microfiber diameter. Thereafter, the meltblown fibers are carried by the gas stream and are deposited on a collecting surface to form a web of random meltblown fibers. Such a process is disclosed, for example, in U.S. Pat. No. 3,849,241, which is incorporated herein in its entirety by reference.

As used herein, the term “needlepunch” refers to a process where different types of fibers, such as polyester, polypropylene, or natural fibers like cotton or wool, are blended together to achieve desired properties like strength, softness, or absorbency. The blended fibers are carded, which aligns them in a web-like structure. This process helps to create a more uniform fiber distribution. The aligned fibers are then laid out to form a loose web. This web serves as the basis for the nonwoven fabric. During needle punching, barbed needles are repeatedly punched through the web. As the needles penetrate through the web, they entangle the fibers, bonding them together mechanically. This process strengthens the fabric and creates a dense, uniform structure. After needle punching, the fabric may undergo additional treatments such as heat setting, calendaring, or chemical treatments to further enhance its properties, such as improving its texture, strength, or water resistance.

As used herein, the term “air-through bonding” refers to a process of producing non-woven, bicomponent fibers by bonding in hot air. Ffibers are selected based on the desired properties of the final fabric. These fibers can be synthetic, natural, or a blend of both. They are often crimped to improve bulkiness and loft. The fibers are then formed into a loose web, either through carding, airlaid, or other methods. This web serves as the initial structure for the fabric. In the air-through bonding process, the web is passed through a stream of hot air. This hot air is directed through the web using a perforated drum or conveyor belt. The heat from the air melts or activates thermoplastic fibers in the web, causing them to bond together at the contact points. This creates a cohesive fabric structure. After bonding, the fabric may pass through a cooling chamber or be subjected to other methods to solidify the bonds and ensure the fabric retains its shape and integrity. The bonded fabric may undergo additional finishing processes such as calendaring or surface treatments to enhance its properties, such as softness, strength, or water repellency.

In some embodiments, The body 32 of the filter 30 can be made of at least two layers detachably deposed on to one another. In some embodiments, the two layers are laid side-by-side and are held in place with by a process that places elastic stitching and/or an elastic band in place, as described further below.

In some embodiments, the first layer (in some embodiments, the inner layer) comprises a non-woven thermoplastic polymer fiber. A non-woven polymer (non-woven) is such that the fibers thereof are maintained randomly. It is thus a sheet consisting of fibers oriented in a particular direction or randomly, bonded by friction and/or cohesion and/or adhesion. The fibers are thus arranged statistically, i.e., deposited randomly. Consequently and due to the random arrangement of the fibers, the non-woven polymer is permeable to substances, and there is no control of the size of the substances that can diffuse within the non-woven polymer. A non-woven membrane is not structured as the porous membranes, and there is no control of diffusion of substance within the non-woven part of the membrane, in contrast to porous membranes, which present a cut-off, depending on the size of pores.

Non-woven polymers can be produced using polymeric fibers of any type. In some embodiments, polymers include polyolefins, e.g., polyethylene, polypropylene, polybutylene, etc.; polytetrafluoroethylene; polyesters, e.g., polyethylene terephthalate and so forth; polyvinyl acetate; polyvinyl chloride acetate; polyvinyl butyral; acrylic resins, e.g., polyacrylate, polymethylacrylate, polymethylmethacrylate, and so forth; polyamides, e.g., nylon; polyvinyl chloride; polyvinylidene chloride; polystyrene; polyvinyl alcohol; polyurethanes; polylactic acid, polyhydroxyalkanoates; copolymers thereof; and so forth. Synthetic or natural cellulosic polymers may also be used, including but not limited to, cellulosic esters; cellulosic ethers; cellulosic nitrates; cellulosic acetates; cellulosic acetate butyrates; ethyl cellulose; regenerated celluloses, such as viscose, rayon, and so forth. It should be noted that the polymer(s) may also contain other additives, such as processing aids or treatment compositions to impart desired properties to the fibers, residual amounts of solvents, pigments, or colorants, and so forth.

In some embodiments, the first layer comprises a needlepunch polypropylene.

Blends of any of the aforementioned polymers with eachother can also be used. As is known in the art, the ratios of fiber-forming polymer blends may be varied to attain a balance of desirable properties and fiber strength. The ratio of polymer A to polymer B may range from about 90:10 to about 10:90, about 85:15 to about 15:85, about 80:20 to about 20:80, about 75:25 to about 25:75, about 70:30 to about 30:70, about 65:35 to about 35:65, about 60:40 to about 40:60, about 55:45 to about 45:55, or about 50:50 depending upon the fiber components selected.

The non-woven fiber may be a dry-laid or wet-laid non-woven fiber or an extrusion nonwoven fiber, in particular a meltblown, spunbond, or spun-blown non-woven fiber. In some embodiments, a non-woven polymer is obtained by the needlepunch method. In some embodiments, the first layer is a 90 gsm needlepunch polypropylene fiber.

The non-woven fibers may comprise staple fibers or continuous fibers. In terms of production engineering, several layers of staple fibers or continuous fibers may also be provided, which are bonded to form a layer of non-woven fabric.

The smoking filter also comprises a second layer (in some embodiments, the outer layer) comprising a non-woven thermoplastic bicomponent polymer fiber.

Bicomponent fibers in which the first component surrounds and thus encloses the second component in the cross-section of the fiber are referred to as core-sheath fibers. Bicomponent fibers in which both the first component and the second component form part of the fiber surface in the cross-section of the fiber are referred to as side-by-side fibers. Fibers with structures in which multiple strands of one component are embedded in a strand of the other component, resulting in an image resembling a plurality of islands formed from one component in cross-section, are referred to as island-in-the-sea fibers. Bicomponent fibers in which a plurality of regions of each component are present in cross-section and form the outer fiber surface are referred to as segmented-pie fibers, since the regions of the individual components regularly have a pie-piece-like division in cross-section.

Each component of the bicomponent fiber can be produced using polymeric fibers of any type. In some embodiments, polymers include polyolefins, e.g., polyethylene, polypropylene, polybutylene, etc.; polytetrafluoroethylene; polyesters, e.g., polyethylene terephthalate and so forth; polyvinyl acetate; polyvinyl chloride acetate; polyvinyl butyral; acrylic resins, e.g., polyacrylate, polymethylacrylate, polymethylmethacrylate, and so forth; polyamides, e.g., nylon; polyvinyl chloride; polyvinylidene chloride; polystyrene; polyvinyl alcohol; polyurethanes; polylactic acid, polyhydroxyalkanoates; copolymers thereof; and so forth. Synthetic or natural cellulosic polymers may also be used, including but not limited to, cellulosic esters; cellulosic ethers; cellulosic nitrates; cellulosic acetates; cellulosic acetate butyrates; ethyl cellulose; regenerated celluloses, such as viscose, rayon, and so forth. It should be noted that the polymer(s) may also contain other additives, such as processing aids or treatment compositions to impart desired properties to the fibers, residual amounts of solvents, pigments, or colorants, and so forth. In some embodiments, the second comprises a non-woven polypropylene/polyethylene fiber. In some embodiments, the second layer is a 19 gsm air-thru bonded bicomponent polypropylene/polyethene fiber.

In some embodiments, the two layers of non-woven polymer have a fabric weight in grams per square meter (GSM or g/m²) of about 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, or 130 GSM. In some embodiments, the two layers of non-woven polymer have a fabric weight in GSM in a range of about 90 to about 130 GSM, about 91 to about 129 GSM, about 92 to about 128 GSM, about 93 to about 127 GSM, about 94 to about 126 GSM, about 95 to about 125 GSM, about 96 to about 124 GSM, about 96 to about 123 GSM, about 97 to about 122 GSM, about 98 to about 121 GSM, about 99 to about 120 GSM, about 100 to about 119 GSM, about 101 to about 118 GSM, about 102 to about 117 GSM, about 103 to about 116 GSM, about 104 to about 115 GSM, about 105 to about 114 GSM, about 106 to about 113 GSM, about 107 to about 112 GSM, about 108 to about 111 GSM, or about 108.5 to about 109.5 GSM.

In some embodiments, the first layer has a fabric weight in GSM of about 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, or 110 GSM. In some embodiments, the first layer has a fabric weight in GSM in a range of about 70 to about 110 GSM, about 71 to about 109 GSM, about 72 to about 108 GSM, about 73 to about 107 GSM, about 74 to about 106 GSM, about 75 to about 105 GSM, about 76 to about 104 GSM, about 76 to about 103 GSM, about 77 to about 102 GSM, about 78 to about 101 GSM, about 79 to about 100 GSM, about 80 to about 99 GSM, about 81 to about 98 GSM, about 82 to about 97 GSM, about 83 to about 96 GSM, about 84 to about 95 GSM, about 85 to about 94 GSM, about 86 to about 93 GSM, about 87 to about 92 GSM, about 88 to about 91 GSM, or about 89.5 to about 90.5 GSM.

In some embodiments, the second layer has a fabric weight in GSM of about 10, 11, 12, 13, 14, 15, 16, 17, 18, 19, 20, 21, 22, 23, 24, 25, 26, 27, or 28 GSM. In some embodiments, the second layer has a fabric weight in GSM in a range of about 10 to about 28 GSM, about 11 to about 27 GSM, about 12 to about 26 GSM, about 13 to about 25 GSM, about 14 to about 24 GSM, about 15 to about 23 GSM, about 16 to about 22 GSM, about 17 to about 21 GSM, or about 18 to about 20 GSM.

In some embodiments, the first layer is inlaid on the second layer without bonding. In some embodiments, the first layer is inlaid on the second layer with bonding.

In some embodiments, the smoke contains carbon monoxide, carbon dioxide, and particulate matter (e.g., soot) as contaminants. In some some embodiments, smoke can also contain different contaminants, such as for example, tar, aldehydes, acid gases, sulfur dioxide, nitrogen oxides, polycyclic aromatic hydrocarbons (PAHs), benzene, toluene, styrene, metals, dioxins, formaldehyde, arsenic; acetaldehyde, ammonia arsenic, benzene, cadmium, chromium, formaldehyde, hydrogen cyanide, isoprene, lead, mercury, nickel, and quinoline.

In some embodiments, the smoke contains microbial contaminants, such as e.g., bacteria, insect, and/or fungi. In some embodiments, the bacteria contaminant is a bacteria from the genera Salmonella, Enterobacter, Streptococcus, or Klebsiella, In some embodiments, the insect contaminant is budworm or mite. In some embodiments, the funji contaminant is powdery mildew, botrylis, or a cotoxin-producing strains of Aspergillus.

In some embodiments, the smoke contains contaminant pesticides including insecticides, fungicides, miticides, and herbicides. In some embodiments, the pesticides comprise carcinogens such as, e.g., carbaryl, diuron, ethoprophos, permethrin, and propargite; endocrine disruptors; and/or developmental, reproductive, and/or neurological toxins.

The presently disclosed two layer smoke filter, in some embodiments, removes all contaminants by at least about 10%, about 11%, about 12%, about 13%, about 14%, about 15%, about 16%, about 17%, about 18%, about 19%, about 20%, about 21%, about 22%, about 23%, about 24%, about 25%, about 26%, about 27%, about 28%, about 29%, about 30%, about 31%, about 32%, about 32%, about 33%, about 34%, about 35%, about 36%, about 37%, about 38%, about 39%, about 40%, about 41%, about 42%, about 43%, about 44%, about 45%, about 46%, about 47%, about 48%, about 49%, about 50%, about 51%, about 52%, about 53%, about 54%, about 55%, about 56%, about 57%, about 58%, about 59%, about 60%, about 61%, about 62%, about 63%, about 64%, about 65%, about 66%, about 67%, about 68%, about 69%, about 70%, about 71%, about 72%, about 73%, about 74%, about 75%, about 76%, about 77%, about 78%, about 79%, about 80%, about 81%, about 82%, about 83%, about 84%, about 85%, about 86%, about 87%, about 88%, about 89%, about 90%, about 91%, about 92%, about 93%, about 94%, about 95%, about 96%, about 97%, about 98%, about 99% or more as compared to a smoking device not comprising the present two layer smoking filter attached thereto.

In some embodiments, the two layer smoke filter removes particulate, microbial, and/or pesticide contaminants by at least about 10%, about 11%, about 12%, about 13%, about 14%, about 15%, about 16%, about 17%, about 18%, about 19%, about 20%, about 21%, about 22%, about 23%, about 24%, about 25%, about 26%, about 27%, about 28%, about 29%, about 30%, about 31%, about 32%, about 32%, about 33%, about 34%, about 35%, about 36%, about 37%, about 38%, about 39%, about 40%, about 41%, about 42%, about 43%, about 44%, about 45%, about 46%, about 47%, about 48%, about 49%, about 50%, about 51%, about 52%, about 53%, about 54%, about 55%, about 56%, about 57%, about 58%, about 59%, about 60%, about 61%, about 62%, about 63%, about 64%, about 65%, about 66%, about 67%, about 68%, about 69%, about 70%, about 71%, about 72%, about 73%, about 74%, about 75%, about 76%, about 77%, about 78%, about 79%, about 80%, about 81%, about 82%, about 83%, about 84%, about 85%, about 86%, about 87%, about 88%, about 89%, about 90%, about 91%, about 92%, about 93%, about 94%, about 95%, about 96%, about 97%, about 98%, about 99% or more as compared to a smoking device not comprising the present two layer smoking filter attached thereto.

In some embodiments, the two layer filter system has a submicron filtration efficiency of at least about 50%, at least about 51%, at least about 52%, at least about 53%, at least about 54%, at least about 55%, at least about 55%, at least about 56%, at least about 57%, at least about 58%, at least about 59%, at least about 60%, at least about 61%, at least about 62%, at least about 63%, at least about 64%, at least about 65%, at least about 66%, at least about 67%, at least about 68%, at least about 69%, at least about 70% or greater according to ASTM F3502-22 (“Standard Specification for Barrier Face Coverings”; ASTM International, Chonshohocken, PA, USA; Section 8.1 (“Submicron Filtration Efficiency”)).

In some embodiments, the two layer filter system has an airflow resistance of at least about 1.10 mm H₂O, at least about 1.11 mm H₂O, at least about 1.12 mm H₂O, at least about 1.13 mm H₂O, at least about 1.14 mm H₂O, at least about 1.15 mm H₂O, at least about 1.16 mm H₂O, at least about 1.17 mm H₂O, at least about 1.18 mm H₂O, at least about 1.19 mm H₂O, at least about 1.20 mm H₂O, at least about 1.21 mm H₂O, at least about 1.22 mm H₂O, at least about 1.23 mm H₂O, at least about 1.24 mm H₂O, at least about 1.25 mm H₂O, at least about 1.26 mm H₂O, at least about 1.27 mm H₂O, at least about 1.28 mm H₂O, at least about 1.29 mm H₂O, at least about 1.30 mm H₂O, at least about 1.31 mm H₂O, at least about 1.32 mm H₂O, at least about 1.33 mm H₂O, at least about 1.34 mm H₂O, at least about 1.35 mm H₂O or more according to ASTM F3502-22 (“Standard Specification for Barrier Face Coverings”; ASTM International, Chonshohocken, PA, USA; Section 8.2 (“Airflow Resistance”)).

In some embodiments, the two layer system has level 2 (higher performance) for submicron filtration efficiency and/or airflow resistance.

Having thus described the filter in detail, it is to be understood that the foregoing description is not intended to limit the spirit or scope thereof. It will be understood that the present disclosure described herein is merely exemplary and that a person skilled in the art may make any variations and modification without departing from the spirit and scope of the disclosure. All such variations and modifications, including those discussed above, are intended to be included within the scope of the disclosure.

### Examples

ASTM F3502-22 (“Standard Specification for Barrier Face Coverings”; ASTM International, Chonshohocken, PA, USA; Section 8.1 (“Submicron Filtration Efficiency”) and Section 8.2 (“Airflow Resistance”)) was used to test a two-layer filter system having (1) 90 gsm needlepunch polypropylene inner layer (i.e., the layer to be placed against a smoking device) and (2) an outer layer of 19 gsm air-thru bonded bicomponent polypropylene/polyethene fiber (sheathe layer that touches the mouth, fingers, etc.).

Performance and testing criteria for ASTM F3502-22 define minimum barrier face covering filtration efficiency and airflow resistance performance properties. Sub-micron particulate filtration efficiency represents the ability to capture and reduce respirable aerosols that potentially contain viruses and bacteria. Airflow resistance represents the wearer's ease of breathing or breathability while wearing the barrier face covering. The impact of repeated cleaning or laundering on continued performance is applied for measuring performance properties for those barrier face coverings that are intended for reuse. Manufacturers are permitted to also provide test results for bacterial filtration efficiency (BFE) as supplemental information to the mandatory performance measurement of sub-micron particulate filtration efficiency.

ASTM F3502-23 establishes a baseline for a source control device and allows for comparison between products. Barrier face coverings (BFCs) provide source control by reducing the number of expelled droplets and aerosols from the wearer's nose and mouth into the air. They also potentially offer a degree of particulate filtration to reduce the amount of inhaled particulate matter by the wearer.

BFCs meeting the enhanced recommendations provide a higher level of performance to help prevent the spread of respiratory viruses. They use enhanced particulate filtration, breathability, and leakage recommendations.

Under ASTM F3502-22, BFCs have Level 2, higher performance for Section 8.1 (submicron filtration efficiency) when the effectiveness for capturing small particles is ≥50%. BFCs have a Level 2, higher performance for Section 8.2 (airflow resistance) when the ease of breathing while wearing the BFC is ≤5 mm H₂O.

Results of Section 8.1 and 8.2 testing of the 90 gsm needlepunch polypropylene/19 gsm air-thru bonded bicomponent polypropylene/polyethene two layer smoking filter are shown Table 1.

TABLE 1

| | | | | Submicron | Airflow |
|---|---|---|---|---|---|
| | Flow Rate | Actual | | Filtration | Resistance |
| Specimen | (L/min) | (%) | (%) | Efficiency | (mm H₂O) |
| 1 | 86.8 | 39.90107 | 60.09893 | 60% | 1.24 |
| 2 | 87.0 | 40.61694 | 59.38306 | 59% | 1.18 |
| 3 | 86.8 | 39.32176 | 60.67824 | 60% | 1.32 |
| 4 | 86.9 | 40.23161 | 59.76839 | 59% | 1.15 |
| 5 | 87.0 | 43.27941 | 56.72059 | 56% | 1.21 |
| 6 | 86.8 | 42.29639 | 57.70361 | 57% | 1.18 |
| 7 | 87.0 | 41.24278 | 58.75722 | 58% | 1.23 |
| 8 | 87.0 | 41.49416 | 58.50584 | 58% | 1.18 |
| 9 | 86.95 | 42.98648 | 57.01352 | 57% | 1.26 |
| 10 | 86.9 | 40.15406 | 59.84594 | 59% | 1.28 |

Under both the Section 8.1 (submicron filtration efficiency) and Section 8.2 (airflow resistance) the 90 gsm needlepunch polypropylene/19 gsm air-thru bonded bicomponent polypropylene/polyethene two layer smoking filter has Level 2, higher performance.

What is claimed is:

1. A filter for a smoking device, comprising:
a body having one or more filter layers positionable over a mouthpiece of a smoking device to filter impurities from smoke drawn through the body;
a collar configured to secure the body over the mouthpiece such that smoke is drawn through the body prior to inhalation by a user; and
means for securing the filter to the mouthpiece.

2. The filter of claim 1, wherein the means for securing the filter comprises an adhesive for securing the collar to the mouthpiece.

3. The filter of claim 1, wherein the means for securing the filter comprises tape.

4. The filter of claim 1, wherein the means for securing the filter comprises cling.

5. The filter of claim 2, wherein the adhesive comprises a tack agent.

6. The filter of claim 2, wherein the adhesive comprises a releasable adhesive.

7. The filter of claim 5, further comprising a package for the filter, the filter having: a first, generally flat, configuration for positioning inside the package for sale and storage and a second, deployed, configuration for positioning the body over the mouthpiece of the smoking device pipe and the collar positioned about a mouthpiece.

8. The filter of claim 6, further comprising a package for the filter, the filter having: a first, generally flat, configuration for positioning inside the package for sale and storage and a second, deployed, configuration for positioning the body over the mouthpiece of the smoking device pipe and the collar positioned about a mouthpiece.

9. The filter of claim 1 wherein at least a portion of the filter extends into a mouthpiece of a smoking device.

10. A smoking filter for a pipe comprising:
a base sized to fit about a side wall of a pipe having open top to secure the smoking filter on the open top; and
one or more filter layers attached to the base.

11. The filter of claim 10, wherein the one or more filter layers comprises a woven and a non-woven material.

12. The filter of claim 10 wherein the base is sized to fit over a mouthpiece of a pipe.

13. The filter of claim 10 wherein the base is rigid.

14. The filter of claim 10 wherein the base is semi-rigid.

15. The filter of claim 14 wherein the base is rubber.

16. The filter of claim 14 wherein the base is plastic.

17. The filter of claim 14 wherein the base is pvc.

18. The filter of claim 13 wherein the base is glass.

19. The filter of claim 13 wherein the base is plastic.

20. A smoking filter for a pipe comprising:
a filter material; and
a base for removeably receiving the filter material,
wherein, the base is removeably attachable to a pipe.
